(19) United States
(12) Patent Application Publication
(10) Pub. No.: US 2010/0299185 A1
(43) Pub. Date: Nov. 25, 2010

(54) Diagnostic Tools and Methods Thereof

(76) Inventor: Ricardo J. Caro, Marietta, GA (US)

Correspondence Address: GREENBERG TRAURIG (HOU);INTELLECTUAL PROPERTY DEPARTMENT, 1000 Louisiana Street, Suite 1700, Houston, TX, 77002, US

(21) Appl. No.: 12/784,269

(22) Filed: May 20, 2010

Related U.S. Application Data
(60) Provisional application No. 61/179,901, filed on May 20, 2009.

(51) Int. Cl. G06Q 10/00; G05B 13/02

(52) U.S. Cl. 705/11; 705/9; 700/104

(57) ABSTRACT

A diagnostic tool for use in adjusting a welding project. The diagnostic tool having an input device adapted to transfer base data into a first computer readable database. The input device further adapted to transfer performance data relating to each welding apparatus into a second computer readable database. The diagnostic tool further having a computer program adapted to transform the base transform the base data and the performance data into optimization data. The diagnostic tool further having an output device adapted to display the optimization data.

### CROSS REFERENCE TO RELATED APPLICATIONS

This patent application claims the benefit, and priority, of U.S. Provisional Patent Application No. 61/179,901, filed on May 20, 2009.

### BACKGROUND OF THE INVENTION

1. Field of the Invention

The present diagnostic tools relate generally to a diagnostic tool for use in connection with welding projects. More specifically, the diagnostic tools can be used to optimize, manage, diagnose, and otherwise improve boiler tube and pressure vessel welding projects.

2. Description of the Related Art

Boiler tubes (also called a waterwall) and pressure vessels, typically made of steel or one or more steel alloys, may be coated with an alloy by weld overlay. Alloys suitable to be used in weld overlay applications are generally known to those of ordinary skill in the art. The alloy overlay generally serves to protect various portions of the boiler or vessel from exposure to elements such as heat, friction, or corrosive chemicals. Over time, these coatings wear and need to be replaced or otherwise serviced. A welding service company may be employed by a customer to remediate, or otherwise service, the boiler tubes or pressure vessels at location. Alternatively, the welding service company may be employed by a customer to affix an initial alloy overlay, or otherwise provide welding services, to the boilers or vessels at the customer's place of business. In order to safely and timely manage these welding projects, the welding company may apportion the overlaying of certain areas of boiler tubes, or various areas of the vessel(s), among one or more welding operators, forepersons, and supervisors. Still further, the welding company may manage multiple welding projects at the same time, and at various locations across the country and/or the world.

### SUMMARY OF THE INVENTIONS

Various illustrative embodiments herein provide a computer readable medium for use in connection with a welding project. In accordance with one aspect of an illustrative embodiment, the welding project may having a plurality of weld zones, each weld zone having a plurality of welding apparatuses, each welding apparatus working a plurality of daily apparatus shifts. The computer readable medium may include a means for receiving base data relating to each of the plurality of welding zones. The computer readable medium may further include a means for receiving performance data relating to each of welding apparatus. The computer readable medium may further include a means for transforming the base data and the performance data into optimization data. The computer readable medium may further include a means for displaying the optimization data.

In an alternative illustrative embodiment herein provided may be a method of using a computer program for adjusting a welding project. The welding project may have a plurality of weld zones, each weld zone having a plurality of welding apparatuses, each welding apparatus operated by an operator, each welding apparatus working a plurality of daily apparatus shifts, each operator working a plurality of daily operator shifts, the computer program embodied on a computer readable medium having computer-executable instructions. The method may include the step of identifying at least one welding project having a plurality of weld zones, each weld zone having a plurality of welding apparatuses, each welding apparatus operated by an operator, each welding apparatus working a plurality of daily apparatus shifts, and each operator working a plurality of daily operator shifts. The method may further include the steps of inputting base data of the welding project into a computer readable database; obtaining performance data of the welding project at least one time per daily apparatus shift; inputting the performance data of the welding project into a second computer readable database; obtaining wire-feed-speed data of the welding project at least two times per daily apparatus shift; inputting the wire-feed-speed data into a third computer readable database; using the computer program to transform the base data, performance data, and wire-feed-speed data into optimization data, the optimization data including at least one generated element selected from the group consisting of: productivity per welding apparatus and progress per welding apparatus; displaying the optimization data on a screen; inspecting the displayed optimization data; identifying a welding apparatus, or operator, having departing optimization data; and adjusting the welding apparatus, or operator, having departing optimization data.

In a still further illustrative embodiment herein provided may be a diagnostic tool for use in adjusting a welding project. The diagnostic tool may have an input device adapted to transfer base data into a first computer readable database. The input device further adapted to transfer performance data relating to each welding apparatus into a second computer readable database. The diagnostic tool further having a computer program adapted to transform the base transform the base data and the performance data into optimization data. The diagnostic tool further having an output device adapted to display the optimization data.

### BRIEF DESCRIPTION OF THE DRAWING

The present diagnostic tools and methods of use may be understood by reference to the following description taken in conjunction with the accompanying drawing figures which are not to scale and contain certain aspects in exaggerated or schematic form in the interest of clarity and conciseness, wherein the same reference numerals are used throughout this description and in the drawings for components having the same structure, and primed, or sequentially lettered, reference numerals are used for components having a similar function and construction to those elements bearing the same unprimed, or sequentially lettered, reference numerals, and wherein:

FIG. 1 is a schematic of an illustrative embodiment of a boiler-tube diagnostic tool, as well as a representative schematic of an environment wherein the boiler-tube diagnostic tool would be used;

FIG. 2 is a schematic of an illustrative embodiment of a pressure-vessel diagnostic tool, as well as a representative schematic of an environment wherein the pressure-vessel diagnostic tool would be used;

FIG. 3 is a schematic of a simplified diagram of a computing module for processing data/information according to an embodiment of the diagnostic tool;

FIG. 4 is a schematic of an simplified flowchart illustrating a method of using the diagnostic tool; and

FIGS. 5-12 are schematic examples illustrating a user interface of the boiler-tube diagnostic tool of FIG. 1.

### DETAILED DESCRIPTION OF THE SPECIFIC EMBODIMENTS

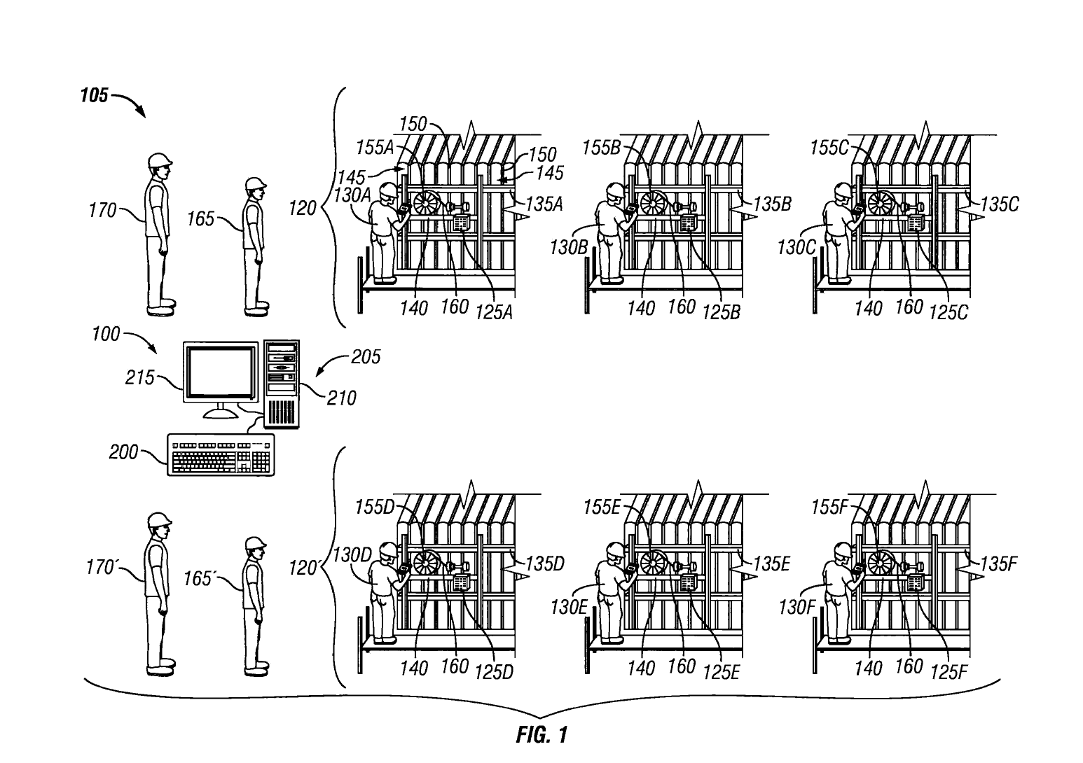

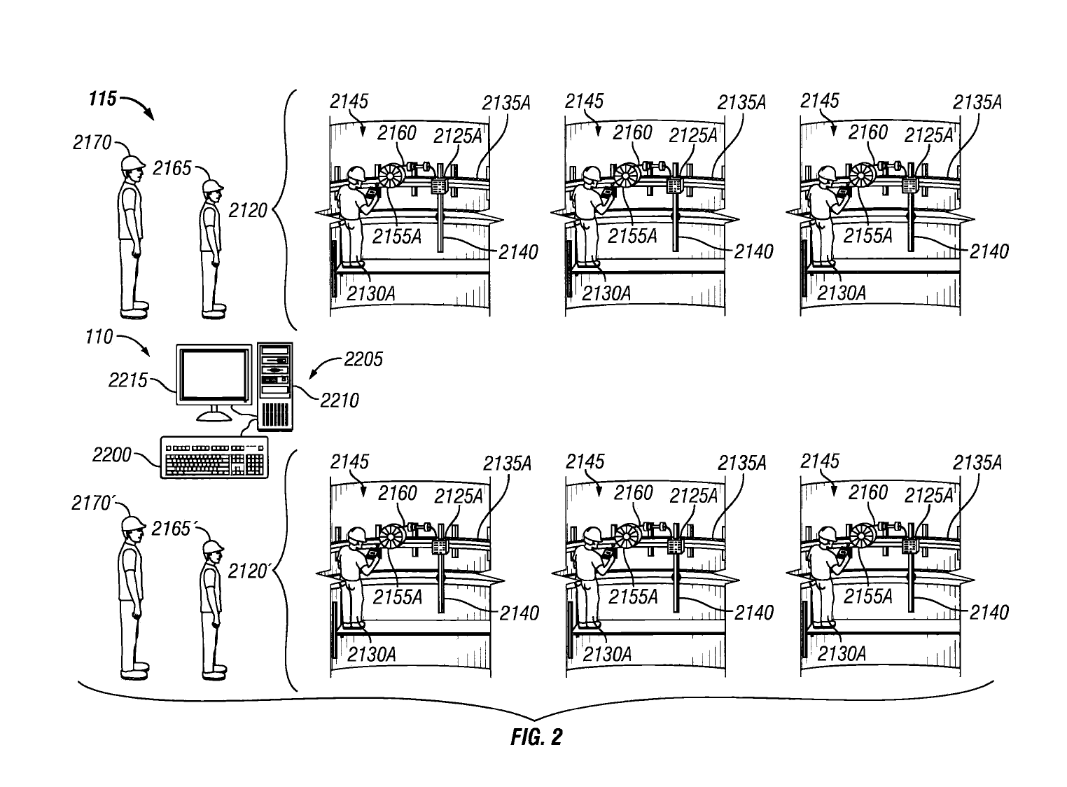

FIG. 1 illustrates a representative first diagnostic tool 100 for adjusting various parameters (as detailed below) of a representative boiler-tube-welding project 105. FIG. 2 illustrates a representative second diagnostic tool 110 for adjusting various parameters (as detailed below) of a representative vessel-welding project 115. While the diagnostic tools 100 and 110 will be described herein in connection with their respective preferred embodiments, it will be understood that it is not intended to limit the diagnostic tools 100 and 110 to those particular embodiments. Instead, more generally, it should be understood that suitable welding projects (not shown) for use in connection with diagnostic tools (not shown), as described herein, may include any large scale, commercial welding job, which requires multiple operators and multiple welding apparatuses.

With reference to FIG. 1, the boiler-tube-welding project 105 may require weld overlaying large areas, ranging from between about 100 and about 10,000 square feet, or more. Often such boiler-tube-welding projects 105 are broken down into two or more theoretical (or actual) component areas or weld zones 120, 120′. The phrase “theoretical weld zone” may be understood to mean that the physical target to be overlaid (for example a waterwall) remains relatively in place, but its various portions are assigned artificial or theoretical welding zones. The phrase “actual weld zone” may be understood to mean that portions of the physical target (for example a waterwall) are disassembled and moved to alternative location(s). Unless otherwise specified this disclosure refers to theoretical weld zones.

Each weld zone may have an area to be overlaid ranging in size from about 10 to about 5,000 square feet, or more. Without wishing to be bound by the theory, Applicant believes that such a deconstruction of the boiler-tube-welding projects 105 makes it more manageable. The exact number of weld zones 120, 120′ into which the boiler-tube-welding project 105 is deconstructed into will depend on a variety of factors including, but not limited to: the overall size of the boiler-tube-welding project 105; the number of welding apparatuses 125a, 125b, 125c, 125d, 125e, and 125f available for use; the number of operators 130a, 130b, 130c, 130d, 130e, and 130, available to constantly monitor each welding apparatus 125a-125f; the time frame in which the boiler-tube-welding project 105 must be completed; and the difficulty of welding each weld zone 120, 120′.

Each welding zone 120, 120′ preferably has a plurality of welding apparatuses 125a-125f. Without limitation, in the illustrative example of FIG. 1 there are three welding apparatuses 125a-125c in welding zone 120 and three welding apparatuses 125d-125f in welding zone 120′. Each welding apparatus 125a-125f is preferably constantly monitored by a respective human operator 130a-130f. A plurality of scaffolds 135a-135f may secure respective welding apparatuses 125a-125f to a plurality of tracks 140. The welding apparatuses 125a-125f may be moveable along the tracks 140 as they apply weld overlay to a respective section of boiler tubes 145 and the area between adjacent boiler-tubes (boiler-tube membranes 150) within the weld zone 120, 120′. Further, spools 155a-155f containing the alloy to be overlaid onto the boiler tubes 145 and boiler-tube membranes 150 are preferably affixed to the tracks 140. The spools 155a-155f may constantly feed the alloy, in the form of a wire 160, to respective welding apparatuses 125a-125f

The operators 130a-130d preferably constantly monitor the welding apparatuses 125a-125f and the resulting weld overlay to ensure a quality and efficient overlay. One or more forepersons 165, 165′ may be assigned to monitor and oversee the welding operation of one or more operators 130a-130f Without limitation, in the illustrative example of FIG. 1 there are two forepersons 165, 165′, and six operators 130a-130f Foreperson 165 may be tasked with monitoring the quality and efficiency of the weld overlay, as well as the overall progress, of the operators 130a-130c. Foreperson 165′ may be tasked with monitoring the quality and efficiency of the overlay, as well as the overall progress, of operators 130d-130f. The quality of the weld overlay may be regulated by the standards set forth by the American Society of Mechanical Engineers (“ASME”), any other standard-setting organization, or the customer. The forepersons 165, 165′ may report various information (as described below) to one or more site supervisors 170, 170′. The site supervisors 170, 170′ may be tasked with the overall quality, efficiency, and progress of their respective weld zone 120, 120′. In an embodiment, the site supervisors 170, 170′ are each tasked with the quality, efficiency, and overall progress of the welding project 105, and may work in alternating shifts. In an alternative embodiment, site supervisor 170 may be tasked with the quality, efficiency, and overall progress of weld zone 120, and site supervisor 170′ may be tasked with the quality, efficiency, and overall progress of weld zone 120′. Further, each site supervisor 170, 170′ may report various information (as described below) to one or more, and preferably one, project manager 175. The project manager 175, who may be located onsite or at a remote location, may be tasked with the quality, efficiency, and overall progress of the boiler-tube project 105.

The quality, efficiency, and overall progress of the boiler-tube project 105 depends on many factors, including, but not limited to: the speed at which the operators 130a-130f work; the number of shifts that each operator 130a-130f works; the type of alloy being overlaid; and the requirements of the particular boiler-tube project 105. In an embodiment, the quality, efficiency, and overall progress of the boiler-tube project 105 is limited by the wire feed speed. For example, in order to achieve the desired weld quality there is often a range in which the wire may be fed into each welding apparatus 125a-125f. The particular range of the wire feed speed, which may vary between about 0.5 square feet per hour to about 10 square feet per hour, is typically specified in a standard set by the ASME, alternative standard setting organization, or the customer. The operators 130a-130f, and forepersons 165, 165′, may be tasked with running the wire feed speed at the fastest rate within the specified range while maintaining a relatively good weld. Relatively good welds may be defined as those welds that are relatively unhindered by weld diffusion, dilution, or excessive heat input. For example, running the wire too quickly can cause the weld overlay to drip (or diffuse) and running the wire too slowly can cause the weld overlay to be overly thin (or diluted), neither of which are generally desirable.

Still with reference to FIG. 1, a simplified diagram of a computing device embodying the diagnostic tool 100 is illustrated. This diagram is, like all embodiments discussed herein, merely an example, which should not limit the scope of the claims herein. One of ordinary skill in the art would recognize many other variations, modifications, and alternatives. Embodiments according to the present diagnostic tool 100 may be, for example, implemented in a single application program such as a browser, or may be implemented as multiple programs in a distributed computing environment, such as a workstation, personal computer or a remote terminal in a client service relationship. FIG. 1 illustrates a diagnostic tool 100 having an input device 200, a computer program 205 stored on a computer 210, and an output device 215. The input device 200 while shown herein as a keyboard may be any other user input device such as a touch screen, light pen, track ball, data glove, voice-recognition medium and the like. The output device 215 while shown herein as a monitor may be any other user output device such as a projector, printer, portable LCD screen, and the like.

With reference to FIG. 2, the pressure-vessel-welding project 115 may require weld overlaying large areas, ranging from between about 100 and about 10,000 square feet, or more. Often such pressure-vessel-welding projects 115 are broken down into two or more theoretical (or actual) component areas or weld zones 2120, 2120′.

Each weld zone may have an area to be overlaid ranging in size from about 10 to about 5,000 square feet, or more. Without wishing to be bound by the theory, Applicant believes that such a deconstruction of the pressure-vessel-welding projects 115 makes it more manageable. The exact number of weld zones 2120, 2120′ into which the pressure-vessel-welding project 115 is deconstructed into will depend on a variety of factors including, but not limited to: the overall size of the pressure-vessel-welding project 115; the number of welding apparatuses 2125a, 2125b, 2125c, 2125d, 2125e, and 2125f available for use; the number of operators 2130a, 2130b, 2130c, 2130d, 2130e, and 2130, available to constantly monitor each welding apparatus 2125a-2125f; the time frame in which the pressure-vessel-welding project 115 must be completed; and the difficulty of welding each weld zone 2120, 2120′.

Each welding zone 2120, 2120′ preferably has a plurality of welding apparatuses 2125a-2125f. Without limitation, in the illustrative example of FIG. 2 there are three welding apparatuses 2125a-2125c in welding zone 2120 and three welding apparatuses 2125d-2125f in welding zone 2120′. Each welding apparatus 2125a-2125f is preferably constantly monitored by a respective human operator 2130a-2130f. A plurality of scaffolds 2135a-2135f may secure respective welding apparatuses 2125a-2125f to a plurality of tracks 2140. The welding apparatuses 2125a-2125f may be moveable along the tracks 2140 as they apply weld overlay to a respective section of the vessel wall or can 2145, or vessel ceiling or head (not shown) within the weld zone 2120, 120′. Further, spools 2155a-2155f containing the alloy to be overlaid onto the vessel can 2145 and vessel head (not shown) are preferably affixed to the tracks 2140. The spools 2155a-2155f may constantly feed the alloy, in the form of a wire 2160, to respective welding apparatuses 2125a-2125f.

The operators 2130a-2130d preferably constantly monitor the welding apparatuses 2125a-2125f and the resulting weld overlay to ensure a quality and efficient overlay. One or more forepersons 2165, 2165′ may be assigned to monitor and oversee the welding operation of one or more operators 2130a-2130f. Without limitation, in the illustrative example of FIG. 2 there are two forepersons 2165, 2165′, and six operators 2130a-2130f. Foreperson 2165 may be tasked with monitoring the quality and efficiency of the weld overlay, as well as the overall progress, of the operators 2130a-2130c. Foreperson 2165′ may be tasked with monitoring the quality and efficiency of the overlay, as well as the overall progress, of operators 2130d-2130f. The quality of the weld overlay may be regulated by the standards set forth by the ASME, any other standard-setting organization, or the customer. The forepersons 2165, 2165′ may report various information (as described below) to one or more site supervisors 2170, 2170′. The site supervisors 2170, 2170′ may be tasked with the overall quality, efficiency, and progress of their respective weld zone 2120, 2120′. In an embodiment, the site supervisors 2170, 2170′ are each tasked with the quality, efficiency, and overall progress of the welding project 2105, and may work in alternating shifts. In an alternative embodiment, site supervisor 2170 may be tasked with the quality, efficiency, and overall progress of weld zone 2120, and site supervisor 2170′ may be tasked with the quality, efficiency, and overall progress of weld zone 2120′. Further, each site supervisor 2170, 2170′ may report various information (as described below) to one or more, and preferably one, project manager 2175. The project manager 2175, who may be located onsite or at a remote location, may be tasked with the quality, efficiency, and overall progress of the pressure-vessel project 115.

The quality, efficiency, and overall progress of the pressure-vessel project 115 depends on many factors, including, but not limited to: the speed at which the operators 2130a-2130f work; the number of shifts that each operator 2130a-2130f works; the type of alloy being overlaid; and the requirements of the particular pressure-vessel project 115. In an embodiment, the quality, efficiency, and overall progress of the pressure-vessel project 115 is limited by the wire feed speed. For example, in order to achieve the desired weld quality there is often a range in which the wire may be fed into each welding apparatus 2125a-2125f. The particular range of the wire feed speed, which may vary, for example, between about 0.5 square feet per hour to about 10 square feet per hour, is typically specified in a standard set by the ASME, alternative standard setting organization, or the customer. The operators 2130a-2130f, and forepersons 2165, 2165′, may be tasked with running the wire feed speed at the fastest rate within the specified range while maintaining a relatively good weld. Relatively good welds may be defined as those welds that are relatively unhindered by weld diffusion, dilution, or excessive heat input. For example, running the wire too quickly can cause the weld overlay to drip (or diffuse) and running the wire too slowly can cause the weld overlay to be overly thin (or diluted), neither of which are generally desirable.

Still with reference to FIG. 2, a simplified diagram of a computing device embodying the diagnostic tool 110 is illustrated. This diagram is, like all embodiments discussed herein, merely an example, which should not limit the scope of the claims herein. One of ordinary skill in the art would recognize many other variations, modifications, and alternatives. Embodiments according to the present diagnostic tool 110 may, for example, be implemented in a single application program such as a browser, or may be implemented as multiple programs in a distributed computing environment, such as a workstation, personal computer or a remote terminal in a client service relationship FIG. 2 illustrates a diagnostic tool 110 having an input device 2200, a computer program 2205 stored on a computer 2210, and an output device 2215. The input device 2200 while shown herein as a keyboard may be any other user input device such as a touch screen, light pen, track ball, data glove, voice-recognition medium and the like. The output device 2215 while shown herein as a monitor may be any other user output device such as a projector, printer, portable LCD screen, and the like.

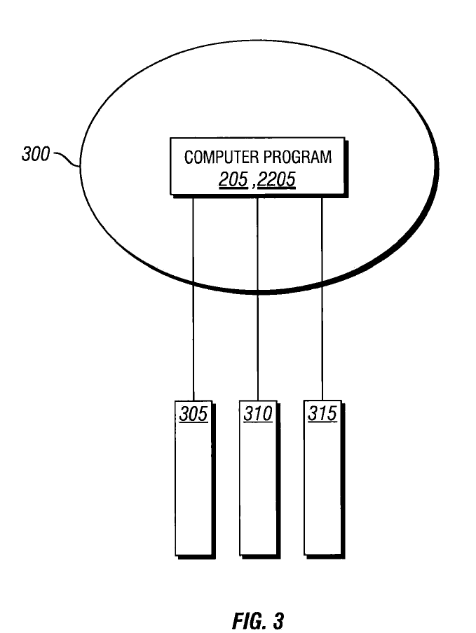

With reference to FIG. 3, a simplified diagram of the computer program 205, 2205 is illustrated. This diagram is, like all embodiments discussed herein, merely an example, which should not limit the scope of the claims herein. One of ordinary skill in the art would recognize many other variations, modifications, and alternatives. By way of example, and not limitation, computer-readable media may include computer storage media and communication media. Computer storage media may include volatile and non-volatile, removable and non-removable media implemented in any method of technology for storage of information such as computer-readable instructions, data, structures, program modules or other data. Computer storage media may include, but is not limited to RAM, ROM, EPROM, EERPOM, flash memory, or other solid state memory technology, CD-ROM, DVD, or other optical storage, magnetic cassettes, magnetic tape, magnetic disk storage or other magnetic storage devices, or any other medium which can be used to store the desired information and which can be accessed by a computer. FIG. 3 illustrates the computer program 205, 2205 stored, or otherwise embodied, on a computer readable medium 300. The computer program 205, 2205 may further include, or otherwise have access to, a one or more databases 305, 310, 315 for storing, or otherwise embodying, data/information inputted using the input device 200, 2200 (shown in FIGS. 1 and 2). In an embodiment, the databases 305, 310, 315 are theoretical portions residing on the same computer storage media. The computer program 205, 2205 may further be comprised of computer-executable instructions for reproducing, displaying, manipulating, generating, or otherwise transforming the inputted data/information into graphical, symbolic, or otherwise human-readable output data/information, preferably displayed via the output device 215, 2215 (shown in FIGS. 1 and 2).

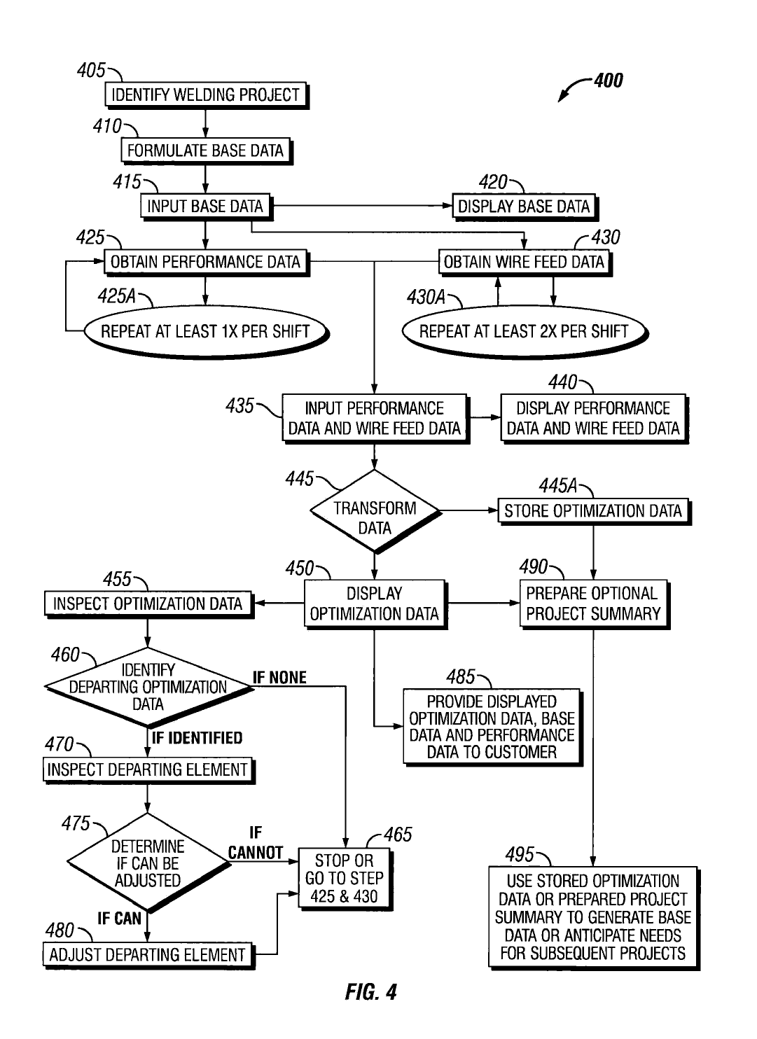

With reference to FIGS. 1 through 4, a simplified flowchart (FIG. 4) of one embodiment of a method of using the boiler-tube diagnostic tool 100 (FIG. 1) or the pressure-vessel diagnostic tool 110 (FIG. 2) is illustrated. As such, the flowchart of FIG. 4 is merely an example, which should not limit the scope of the claims herein. One of ordinary skill in the art would recognize many other variations, modifications, and alternatives. Flowchart 400 begins with step 405. In step 405 of the present embodiment, a welding project 105 or 115 may be identified to be used in connection with the boiler-tube diagnostic tool 100 or the pressure-vessel diagnostic tool 110. For ease of reference, and in the interest of simplicity, FIGS. 3 and 4 will be further described with respect to the boiler-tube welding project 100; however, it should be readily understood that the same description, with appropriate modifications, may apply to the pressure-vessel welding project 110. The welding project 105 is typically identified by the welding project manager 175, but may be identified by the site supervisors 170, 170′, or any other person.

Upon identification of the welding project 105 base data relating to the welding project 105 or 115 may be formulated in step 410. The base data of step 410 may include planned elements, which may be sufficient to render the welding project recognizable to a human, as well as specifying the anticipated needs and goals of the welding project 105. In this manner, the base data may relate to the welding project 105 as a whole, the individual welding zones 120, 120′, or both the welding project 105 as a whole and the individual welding zones 120, 120′. In an embodiment, the planned elements include such data/information as: a project identifier; an overlay start date; an anticipated number of total shifts; a shift-start date; a customer name; a project manager name; a lead superintendent name; an alloy type; an anticipated project duration; a project start date; a number of weld zones; a number of welding apparatuses per each weld zone; a total area of overlay to be applied; a number of spools available to the welding project; and an amount of wire per spool.

In step 415, the base data may be inputted into a first database 305 (FIG. 3) of, or associated with, the computer program 205. In an embodiment, each site supervisor 170, 170′ may have a separate diagnostic tool 100 (only one shown), and may input the base data, using the input device 200, which provides a means for receiving base data relating to each of the plurality of weld zones 120, 120′. Alternatively, the site supervisor 170, 170′, project manager 175, or any other person, may delegate the task of inputting the base data to any person using the input device 200, which provides an alternative means for receiving base data relating to each of the plurality of weld zones 120, 120′. In this embodiment, each welding project may make use of multiple diagnostic tools 105 (only one shown) each embodied in a separate computer 210 (only one shown), and each assigned to a particular welding zone 120, 120′. In a still further embodiment, a single diagnostic tool 105 may be provided and the base data may be inputted, either by the site supervisor 170, 170′ or any other person, into a single computer 210.

In optional step 420, the base data may be displayed on the output device 215. In this manner, the accuracy of the base data can more easily ensured. Preferably, but not necessarily, steps 405 through 420 are completed before starting to weld the boiler tubes 145 or membranes 150 of the welding project 105.

In step 425, with welding underway, performance data may be obtained. The performance data of step 425 may include progress elements relating to each welding apparatus 125a-125f, and/or each operator 130a-130f, within a welding zone 120, 120′. In an embodiment, the progress elements of the performance data of step 425 may include: a number of boiler tubes and membranes (also called “targets”) overlaid per welding apparatus; a number of targets overlaid per operator; a size (in square feet) of targets overlaid per welding apparatus; a size (in square feet) of targets overlaid per operator; an amount of wire (in pounds) used per welding apparatus; an amount of wire (in pounds) used per operator; an area (in square feet) overlaid per welding apparatus; an area (in square feet) overlaid per operator; and the like. In an embodiment, the performance data of step 425 may be gathered by the foreperson 165, 165′. In such an embodiment, the foreperson 165, 165′ may physically walk past each of his/her assigned operators 130a-130f and request or observe the desired performance data. The foreperson 165, 165′ may record performance data, using a writing implement and paper, or electronically, and provide the performance data to the site supervisor 170, 170′. In an alternative embodiment, the performance data of step 425 may be gathered by the welding apparatuses 125a-125f themselves and electronically transmitted, either wirelessly or through a cable, after a periodic, predetermined amount of time, to a database 305. As welding continues in the welding project 105, performance data may be updated, periodically or sporadically, as illustrated by step 425a. Preferably, performance data is obtained periodically one time per working shift, each shift typically lasting 12 hours; however, performance data may be obtained and updated at any desired frequency, either more or less often.

In step 430, with welding underway, wire feed data may be gathered or obtained. The wire feed data of step 430 may include progress elements relating to each welding apparatus 125a-125f, and/or each operator 130a-130f, within a welding zone 120, 120′. In an embodiment, the progress elements of the wire feed data of step 430 may include the wire feed speed per welding apparatus or the wire feed speed per operator. In an embodiment, the wire feed data 430 may be gathered or obtained by the foreperson 165, 165′. In such an embodiment, the foreperson 165, 165′ may physically walk past each of his/her assigned operators 130a-130f and request or observe the desired wire feed data. The foreperson 165, 165′ may record wire feed data, using a writing implement and paper, or electronically, and provide the performance data to the site supervisor 170, 170′. In an alternative embodiment, the wire feed data of step 425 may be gathered by the welding apparatuses 125a-125f, or spools 155a-155b, themselves and electronically transmitted, either wirelessly or through a cable, after a periodic, predetermined amount of time, to a database 305. As welding continues in the welding project 105, wire feed data may be updated, periodically or sporadically, as illustrated by step 430a. Preferably, wire feed data is obtained periodically four times per working shift, each shift typically lasting 12 hours; however, wire feed data may be obtained and updated at any desired frequency, either more or less often.

In step 435, the performance data and wire feed data may be inputted into a second database 310 (as shown in FIG. 3) of, or associated with, the computer program 205. In an alternative embodiment, the first database 305 and the second database 310 are the same database. In a further embodiment, each site supervisor 170, 170′ may have a separate diagnostic tool 105, and may input the performance data and wire feed data, using the input device 200, which provides a means for receiving performance data relating to each welding apparatus. Alternatively, the site supervisor 170, 170′, project manager 175, or any other person, may delegate the task of inputting the performance data and wire feed data to any person, which provides an alternative means for receiving performance data relating to each welding apparatus. In this embodiment, each welding project may make use of multiple diagnostic tools 105 (only one shown) each embodied in a separate computer 210, and each assigned to a particular welding zone 120, 120′. Alternatively, a single diagnostic tool 105 may be provided and the performance data and wire feed data may be inputted, either by the site supervisor 170, 170′ or any other person, into a single computer 210.

In optional step 440, the performance data and wire feed data may be displayed on the output device 215. In this manner, the person who input the performance data and wire feed data can more easily ensure its accuracy.

In step 445 the computer program 205 may read the base data, performance data, and wire feed data stored in respective databases 305, 310, and—through a series of computer readable instructions—transform, or otherwise manipulate, the base data, performance data, and wire feed data into optimization data. In this manner, the computer program 205 may provide a means for transforming the base data and performance data into optimization data. The optimization data of step 445 may include generated elements, which may be sufficient to track the progress of the welding project 105 or otherwise provide comparable information to the user relating to the various welding apparatuses 125a-125f, operators 130a-130f, or spools 155a-155f. The generated elements may include: a productivity, or an average amount of area (in square feet) overlaid, per shift; productivity, or an average amount of area (in square feet) overlaid, per welding apparatus; productivity, or an average amount of area (in square feet) overlaid, per operator; progress, the total amount of area (in square feet) overlaid, per project; progress, the total amount of area (in square feet) overlaid, per weld zone; progress, the total amount of area (in square feet) overlaid, per operator; progress, the total amount of area (in square feet) overlaid, per welding apparatus; wire gage (in pounds) consumed per weld zone; wire gage (in pounds) remaining per weld zone; wire gage (in pounds) consumed per apparatus; wire gage (in pounds) remaining per apparatus. For example, the computer program 205 may obtain the generated element “progress per weld zone” by first calculating the area overlaid per welding apparatus per shift in a given weld zone, either 120 or 120′. Then, the computer program 205 may add together each of the overlaid areas per shift in a given weld zone to arrive at the “progress per weld zone.” In an alternative example, the computer program 305 may obtain the generated element “productivity by welding apparatus” by first calculating the area overlaid per welding apparatus per shift. Then, the computer program 205 may compute the numerical average of each overlaid area per shift, of each welding apparatus, to arrive at the “productivity by welding apparatus.”

In step 450, the optimization data may be displayed on the output device 215, which provides a means for displaying the optimization data. A user of the diagnostic tool 105, such as for example the site supervisor 170, 170′, or the project manager 175, may visually inspect the displayed optimization data in step 455. In step 460, the user of the diagnostic tool 105, such as for example the site supervisor 170, 170′, or the project manager 175, may identify departing optimization data. In an embodiment, departing optimization data is any optimization data that is unusually high or low, as compared to other comparable optimization data. In an alternative embodiment, departing optimization data is any optimization data that is more than one statistical standard deviation above or below the average comparable optimization data. If no departing optimization data is not identified, the method 400 may then stop at step 465, or repeat to steps 425 and 430. If departing optimization data is identified in step 460 then the method 400 may continue to step 470. In step 470 a human, optionally the site supervisor 170, 170′, the foreperson 165, 165′, or the operators 130a-130f, or optionally an “electric eye” (not shown) such as a laser scanner for detecting surface defects, may inspect the departing element to determine if an adjustment can be made, as per step 475. If the human, optionally the site supervisor 170, 170′, the foreperson 165, 165′, or the operators 130a-130f, or electric eye (not shown) determines that an adjustment can be made in step 475, the method continues to step 480 wherein the adjustment is made either by human intervention or by auto-generated electric signal (not shown). If the human, optionally the site supervisor 170, 170′, the foreperson 165, 165′, or the operators 130a-130f, or electric eye, determines that an adjustment cannot be made in step 475, the method then either stops or repeats to steps 425 and 430.

In a first non-limited-illustrative-prophetic example, the “productivity by welding apparatus” of welding apparatus 125a-125c may be 1.2 square foot per shift, 1.3 square foot per shift, and 0.5 square feet per shift, respectively. The departing optimization data indentified may be the “productivity by welding apparatus” of welding apparatus 125c. Continuing with the first non-limited-illustrative-prophetic example, upon identification of the “productivity by welding apparatus” of welding apparatus 125c as departing optimization data, the site supervisor 170 may instruct the foreperson 165 to visually inspect welding apparatus 125c. Upon visual inspection of the welding apparatus 125c, the foreperson 165 may to determine if an adjustment can be made to welding apparatus 125c in order to correct, or otherwise change, its departing optimization data. If an adjustment can be made to the welding apparatus 125c, the foreperson 165 or operator 130c makes the adjustment. If the adjustment cannot be made to the welding apparatus 125c, the foreperson 165 may gather additional performance data, wire feed data, or do exit the method 400.

In a second non-limited-illustrative-prophetic example, the “productivity by welding apparatus” of welding apparatus 125a-125c may be 1.1 square foot per shift, 1.2 square foot per shift, and 0.4 square feet per shift, respectively. The departing optimization data indentified may be the “productivity by welding apparatus” of welding apparatus 125c. Continuing with the second non-limited-illustrative-prophetic example, upon identification of the “productivity by welding apparatus” of welding apparatus 125c as departing optimization data, the electric eye (not shown) may inspect using a laser scanner (not shown) at least a portion of the weld overlay applied by welding apparatus 125c. Upon inspection of the portion of the weld overlay applied by welding apparatus 125C, the computer program 205 may to determine if an adjustment can be made to correct, or otherwise change, its departing optimization data. If an adjustment can be made the computer program 205 may automatically send an electric signal to the welding apparatus 125c to make the adjustment, such as for example, increasing the wire feed speed.

In an alternative embodiment, the optimization data obtained in step 445 may be stored into a database, as provided for in step 445A. In step 490, the stored optimization data may be used to create optional project summaries. In step 495, the project summaries may be used by humans such as for example, project managers 175, and site supervisors 170, 170′, to anticipate the needs of future welding projects based on the historical data obtained and stored in step 445A. In another embodiment, in step 495, the historical data obtained and stored in step 445A can be used to generate accurate base data for future welding projects.

Boiler-Tube Welding Project Example

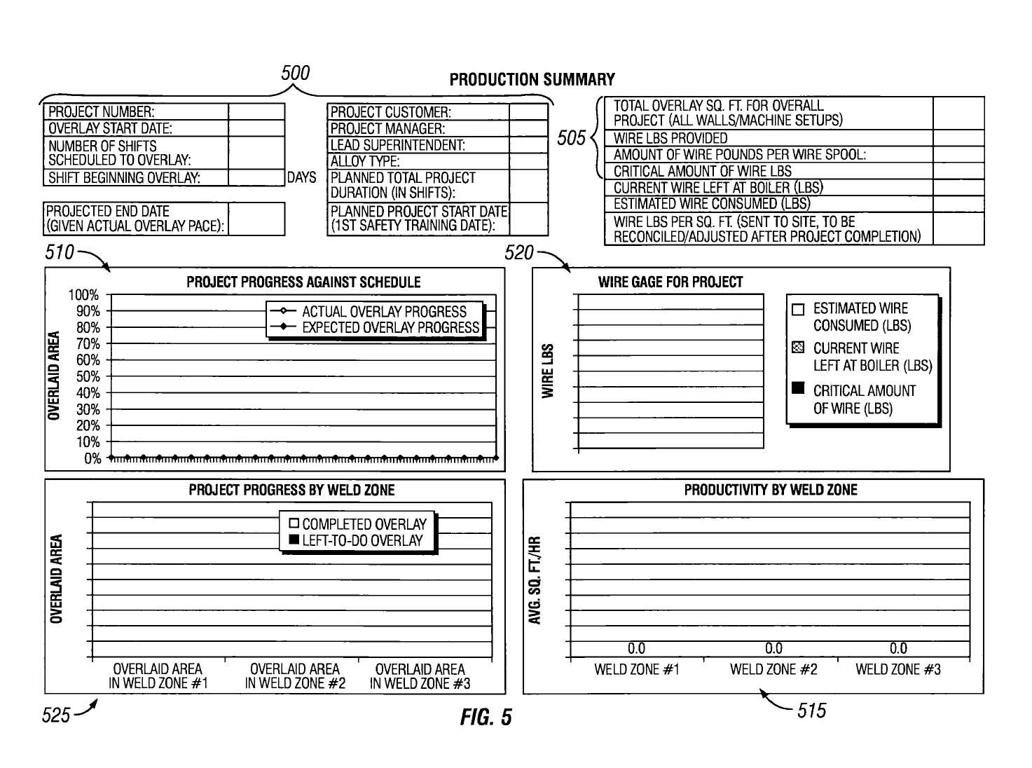

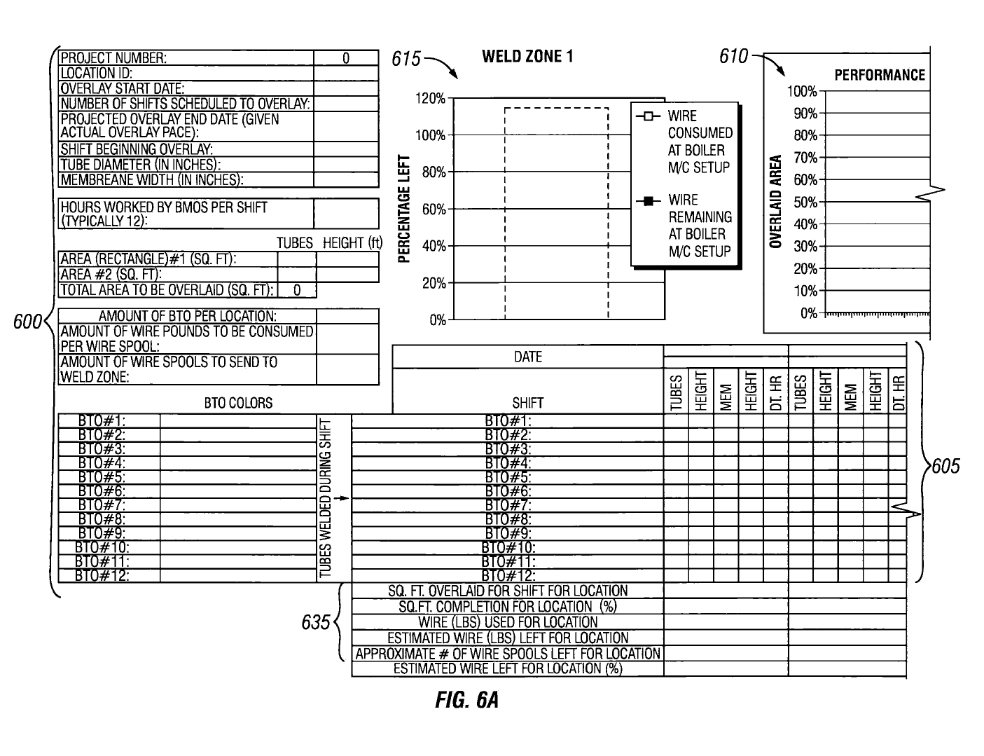

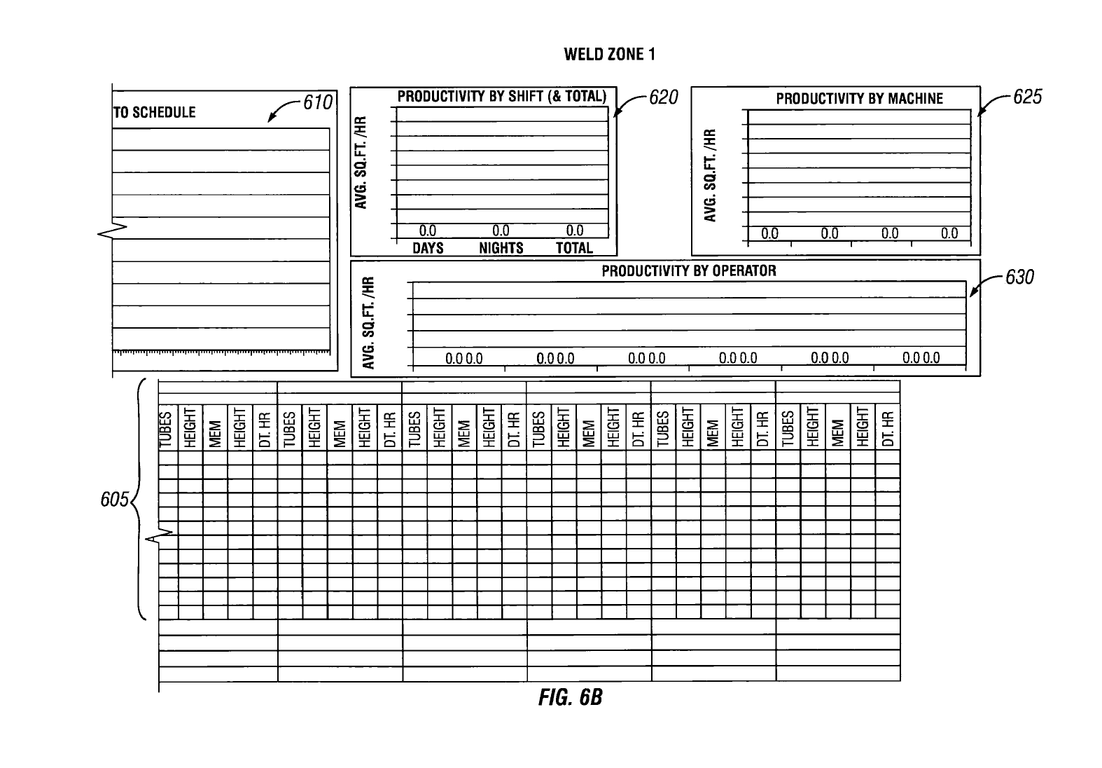

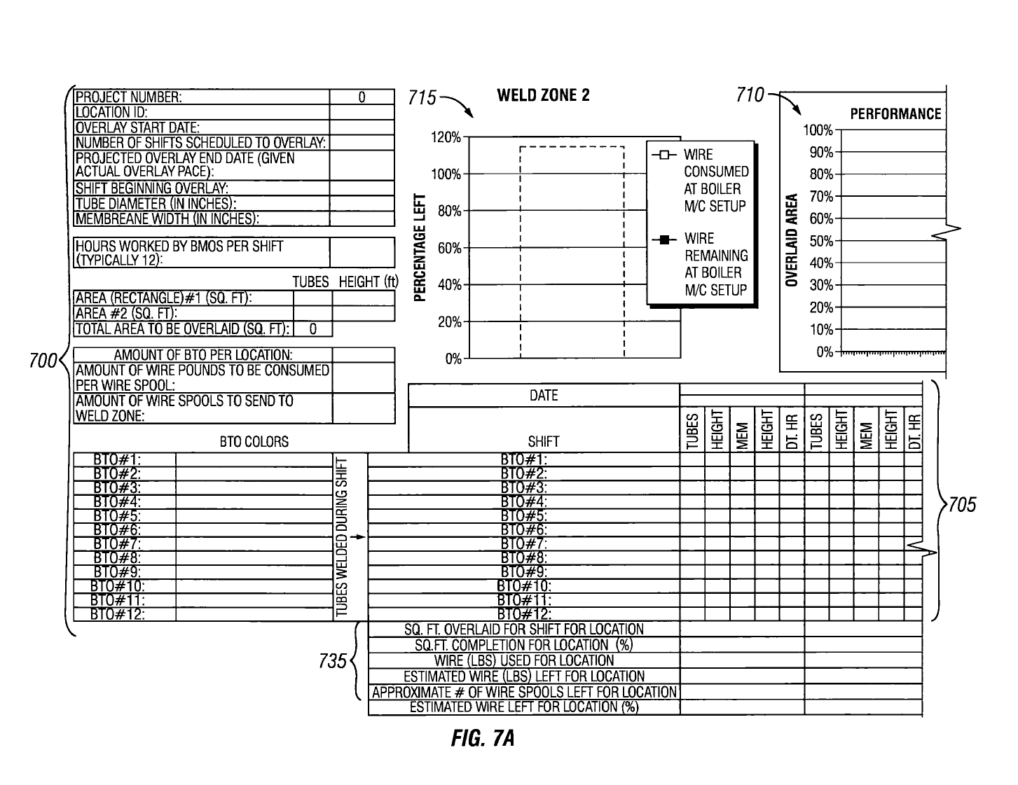

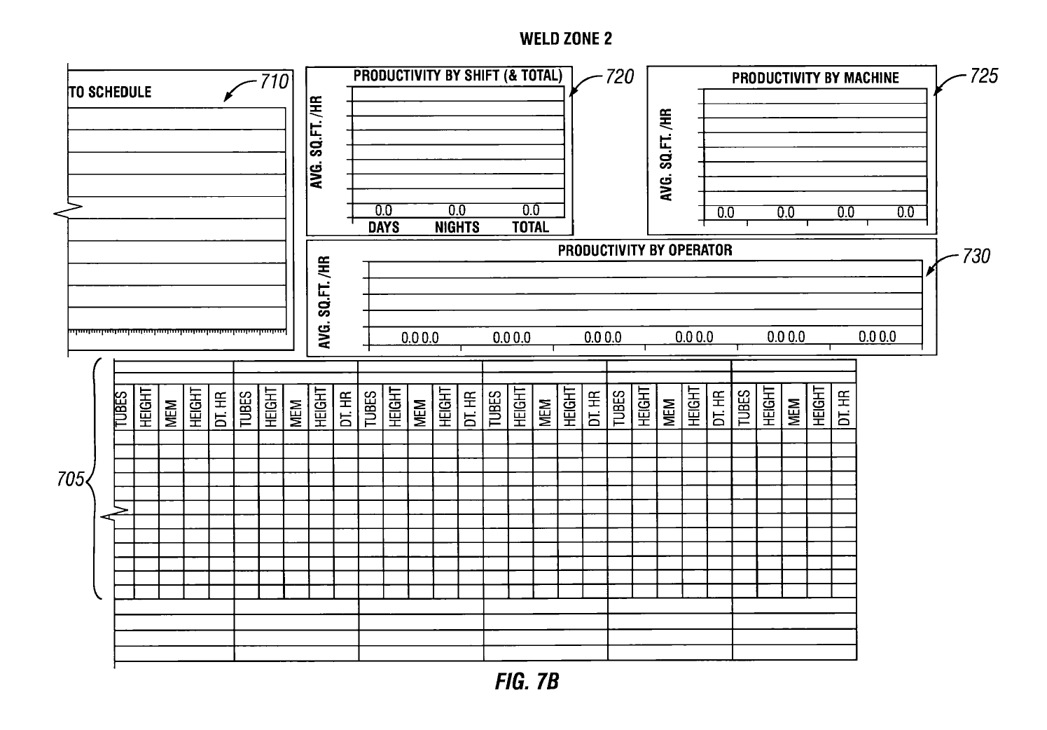

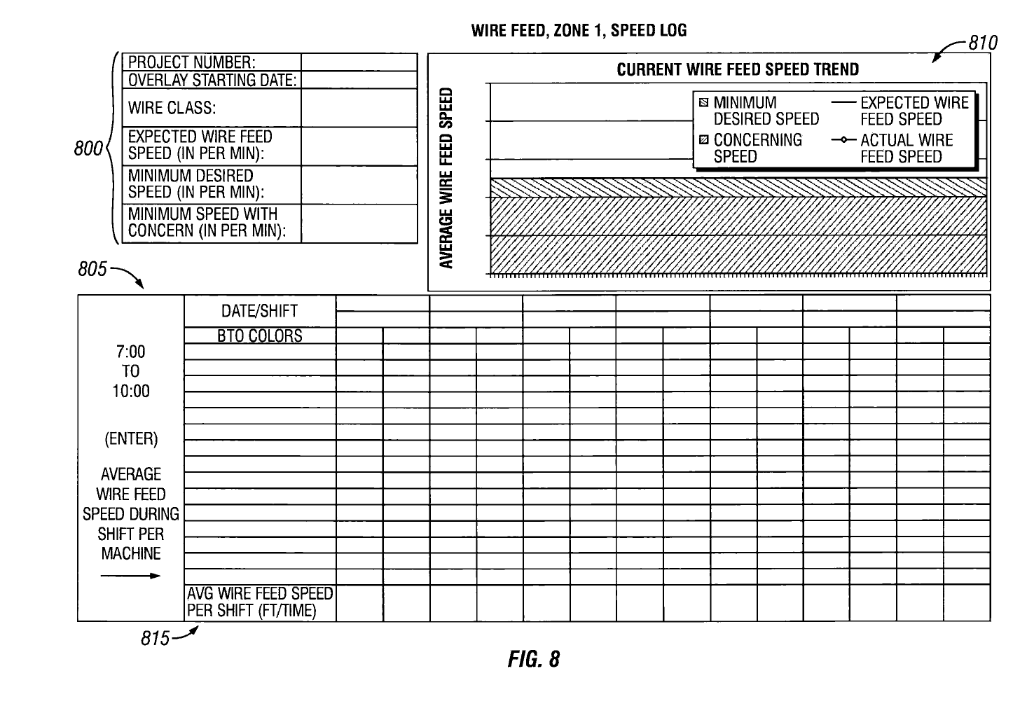

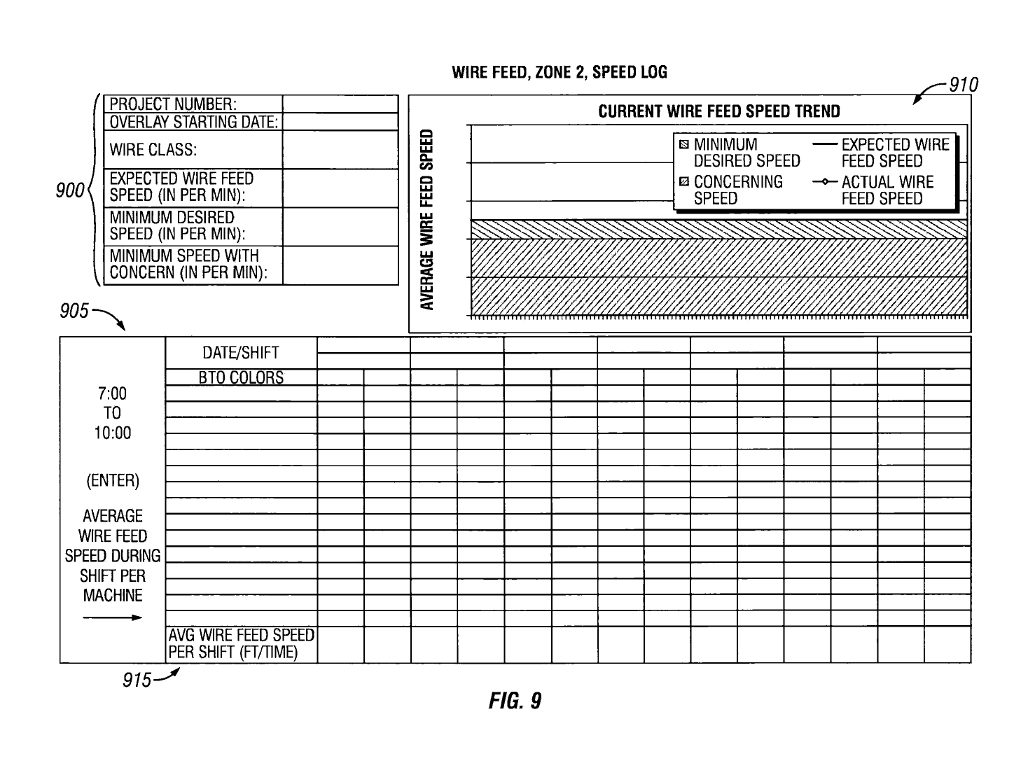

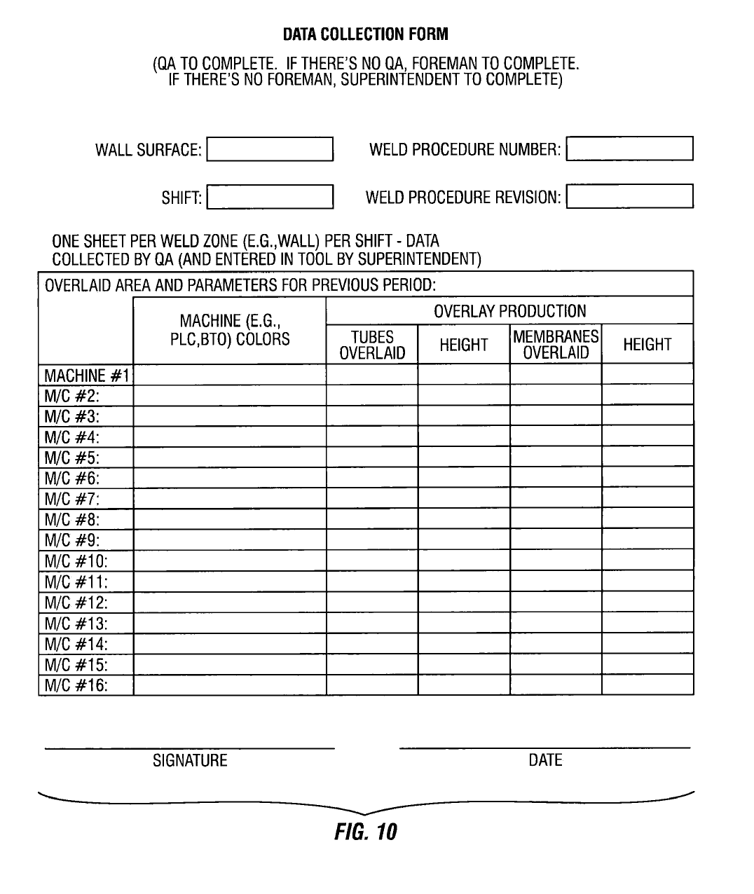

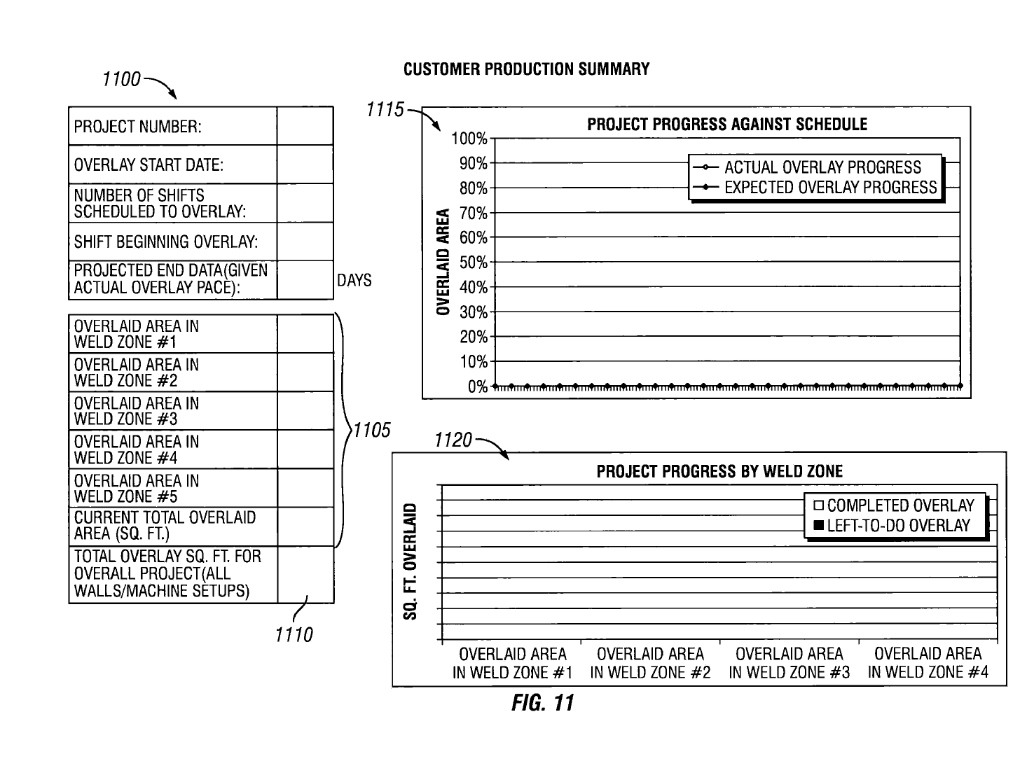

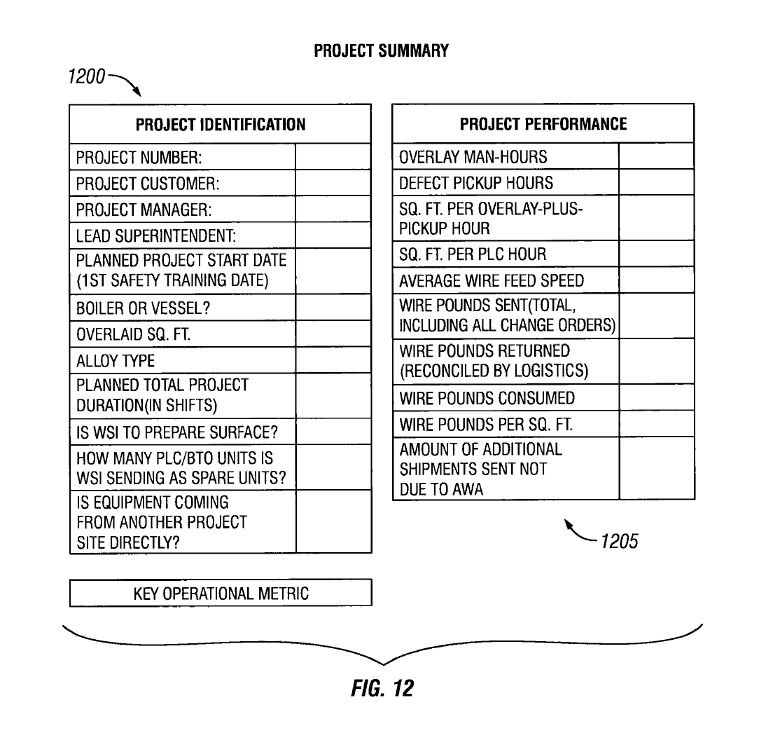

For ease of reference, and in the interest of simplicity, FIGS. 5-12 and the disclosure of this example, are directed toward and illustrate a user interface of a boiler-tube diagnostic tool 105. It should be readily understood, however, that the same description, with appropriate modifications, may apply to the pressure-vessel diagnostic tool 110. In this embodiment, the user may interface with the boiler-tube diagnostic tool 105 using Microsoft's Excel Spreadsheet, having a plurality of sheets and cells within the tabs. FIG. 5 includes a representative diagram of a first sheet, entitled “production summary.” FIGS. 6A and 6B include a representative diagram of a second sheet, entitled “weld zone 1.” FIGS. 7A and 7B include a representative diagram of a third sheet, entitled “weld zone 2.” FIG. 8 includes a representative diagram of a fourth sheet, entitled “wire feed, zone 1, speed log.” FIG. 9 includes a representative diagram of a fifth sheet, entitled “wire feed, zone 2, speed log.” FIG. 10 includes a representative diagram of a sixth sheet, entitled “data collection form.” FIG. 11 includes a representative diagram of a seventh sheet, entitled “customer production summary.” FIG. 12 includes a representative diagram of a eighth sheet, entitled “project summary.”

In an embodiment, the user interface of the boiler-tube diagnostic tool 105 embodied in FIGS. 5-12 may be used in conjunction with the flowchart 400 of FIG. 4. For example, the user, typically the foreperson 165, 165′, or the site supervisor 170, 170′, may input the base data according to step 415 into cells within area 500 and 505 of FIG. 5. And the base data once inputted may be displayed, as per step 420, in a respective cell. The base data input into the cells within area 500 may include: the project number; the overlay start date; the number of shifts scheduled to overlay; the shift beginning overlay date; the projected end date; the project customer; the project manager; the lead superintendent; the alloy type; the planned total project duration (preferably in shifts); and the planned project start date. The base data input into cells within area 505 may include: the total overlay for the overall project (in square feet); the amount of wire (in pounds) initially provided to the project; the amount of wire per wire spool (in pounds); and the critical amount of wire (in pounds) below which additional wire needs to be ordered or otherwise obtained. Base data may additionally be entered into the cells within area 600 of FIG. 6; the cells within area 700 of FIG. 7; the cells within area 800 of FIG. 8; and the cells within area 900 of FIG. 9. The base data input into the cells within areas 600, 700, 800, and 900 may include: the project number; a welding zone location identification number; the overlay start date of the welding zone; the number of shifts scheduled to complete the welding zone; the projected end day; the anticipated shift beginning date; the average tube diameter on a per welding zone basis; the average tube height on a per welding zone basis; the anticipate length of each shift; the number of welding apparatuses assigned to each welding zone; identifying information of each welding apparatus, for example, each welding apparatus may be assigned a color code; a wire class; a minimum desired speed of wire (in feet per minute); and a minimum speed of concern of wire (in feet per minute).

The forepersons 165, 165′ may use the sixth sheet of FIG. 10 entitled “data collection form” to assist in step 425, obtaining performance data. The forepersons 165, 165′ may print the sixth sheet of FIG. 10 onto paper, and fill out the same using writing implements, as the forepersons 165, 165′ inspect each welding apparatus 125a-125f within their welding zone 120, 120′. The sixth sheet of FIG. 10 may include space for entering various performance and base data such as an identification of each welding apparatus to be inspected; the number of tubes overlaid by each welding apparatus as of the inspection time; the height of each tube overlaid by each welding apparatus as of the inspection time; the number of membranes overlaid by each welding apparatus as of the inspection time; the height of each membranes overlaid by each welding apparatus as of the inspection time; the location of the wall surface; the shift number; the weld procedure number; the weld procedure revision, if any; the identification of the person obtaining the performance data; the wire feed speed per welding apparatus (not shown); and the date and time at which the performance data has been obtained.

The foreperson 165, 165′ may provide the completed sixth sheet of FIG. 10 entitled “data collection form” to the site supervisor 170, 170′, or any designated person to perform step 435, inputting the performance data into the computer program 205. In an embodiment, the foreperson 165, 165′ may him or herself input the performance data into the computer program 205. In an embodiment, the performance data of welding zone 120 may be inputted into area 605 of the second sheet of FIGS. 6A and 6B; the performance data of welding zone 120′ may be inputted into area 705 of the second sheet of FIGS. 7A and 7B; the performance data of welding zone 120 may be inputted into area 805 of the third sheet of FIG. 8; the performance data of welding zone 120′ may be inputted into area 905 of the fourth sheet of FIG. 9.

Step 445, displaying the optimization data, of the flowchart 400 of FIG. 4, may additionally be embodied within the sheets of FIGS. 5-9. For example, following step 445, preformed in the background of the computer program 205: a “project progress against schedule” graph may be displayed in area 510; a “productivity by weld zone” graph may be displayed in area 515; a “wire gage consumption” chart may be displayed in area 520; and a “project by weld zone” chart may be displayed in area 525. The “project progress against schedule” graph displayed in area 510 may illustrate comparative graphical line-charts representing the percent of the project completed over time against the percent of the project as scheduled to be completed over time. The “productivity by weld zone” graph displayed in area 515 may illustrate bar graphs showing the average area (in square feet) welded per hour, by weld zone. The “wire gage consumption” chart displayed in area 520 may illustrate bar graphs showing the estimated wire used (in pounds), the current wire available (in pounds), and the critical amount of wire (in pounds) below which additional wire must be ordered or otherwise obtained. The “project progress by weld zone” chart displayed in area 525 may illustrate comparative bar graphs showing the, per weld zone, the area (in square feet) of completed overlay as well as the area (in square feet) of overlay remaining to be welded.

Continuing with reference to FIGS. 6A and 6B and step 445 of FIG. 4, various optimization data may be displayed, as follows: a “weld zone performance to schedule” chart, per welding zone 120, in area 610; a “weld zone wire gage consumption” chart, per welding zone 120, in area 615; a “productivity by shift” chart, per welding zone 120, in area 620; a “productivity by machine” chart, per welding zone 120, in area 625; a “productivity by operator” chart, per welding zone 120, in area 630; and a “production per shift” table, per welding zone 120, in area 635. The “weld zone performance to schedule” chart in area 610 may illustrate comparative graphical line-charts representing the percent of the weld zone 120 completed over time against the percent of the weld zone 120 as scheduled to be completed over time. The “weld zone wire gage consumption” chart displayed in area 615 may illustrate bar graphs showing the estimated wire used (in pounds), per weld zone 120, and the current wire available (in pounds), per weld zone 120. The “productivity by weld shift” chart displayed in area 620 may illustrate bar graphs showing the average area (in square feet) welded per hour, by shift, in the weld zone 120. The “productivity by machine” chart displayed in area 625 may illustrate bar graphs showing the average area (in square feet) welded per hour, by welding machine, in the weld zone 120. The “productivity by operator” chart displayed in area 630 may illustrate bar graphs showing the average area (in square feet) welded per hour, by each operator, in the weld zone 120. The “production per shift” table show the numerical area (in square feet) overlaid during each shift, per weld zone 120; the completed percentage of area (in square feet) overlaid during each shift, per weld zone 120; the amount of wire (in pounds) used during each shift, per weld zone 120; the estimated amount of wire (in pounds) remaining after each shift, per weld zone 120; the approximate number of spools remaining after each shift, per weld zone 120; and the estimated percentage of wire remaining after each shift, per weld zone 120.

Continuing with reference to FIGS. 7A and 7B and step 445 of FIG. 4, various optimization data may be displayed, as follows: a “weld zone performance to schedule” chart, per welding zone 120′, in area 710; a “weld zone wire gage consumption” chart, per welding zone 120′, in area 715; a “productivity by shift” chart, per welding zone 120′, in area 720; a “productivity by machine” chart, per welding zone 120′, in area 725; a “productivity by operator” chart, per welding zone 120′, in area 730; and a “production per shift” table, per welding zone 120′, in area 735. The “weld zone performance to schedule” chart in area 710 may illustrate comparative graphical line-charts representing the percent of the weld zone 120′ completed over time against the percent of the weld zone 120′ as scheduled to be completed over time. The “weld zone wire gage consumption” chart displayed in area 715 may illustrate bar graphs showing the estimated wire used (in pounds), per weld zone 120′, and the current wire available (in pounds), per weld zone 120′. The “productivity by weld shift” chart displayed in area 720 may illustrate bar graphs showing the average area (in square feet) welded per hour, by shift, in the weld zone 120′. The “productivity by machine” chart displayed in area 725 may illustrate bar graphs showing the average area (in square feet) welded per hour, by welding machine, in the weld zone 120′. The “productivity by operator” chart displayed in area 730 may illustrate bar graphs showing the average area (in square feet) welded per hour, by each operator, in the weld zone 120′. The “production per shift” table show the numerical area (in square feet) overlaid during each shift, per weld zone 120′; the completed percentage of area (in square feet) overlaid during each shift, per weld zone 120′; the amount of wire (in pounds) used during each shift, per weld zone 120′; the estimated amount of wire (in pounds) remaining after each shift, per weld zone 120′; the approximate number of spools remaining after each shift, per weld zone 120′; and the estimated percentage of wire remaining after each shift, per weld zone 120′.

Continuing with reference to FIG. 8 and step 445 of FIG. 4, various optimization data may be displayed, as follows: a “wire feed speed” chart, per welding zone 120, in area 810; and “machine average wire feed speed” data or information, per welding zone 120, per welding apparatus, in area 815. The “wire feed speed” chart in area 810 may illustrate the average wire feed speed (in feet per minute) over unit time, per welding zone 120. The “wire feed speed” chart in area 810 may further include an indicator, which graphically illustrates the minimum desired speed (in feet per minute). The “wire feed speed” chart 810 may also include an indicator, which graphically illustrates the minimum speed of concern (in feet per minute) below which is an indication of improper or inefficient welding. The “machine average wire feed speed” data or information may illustrate the average wire feed speed (in feet per minute) per welding machine. The “machine average wire feed speed” data or information may be calculated on a per shift basis, or on a per period basis. In an embodiment, one period may be three hours long, and there may be four periods in a shift.

Continuing with reference to FIG. 9 and step 445 of FIG. 4, various optimization data may be displayed, as follows: a “wire feed speed” chart, per welding zone 120′, in area 910; and “machine average wire feed speed” data or information, per welding zone 120′, per welding apparatus, in area 915. The “wire feed speed” chart in area 910 may illustrate the average wire feed speed (in feet per minute) over unit time, per welding zone 120′. The “wire feed speed” chart in area 910 may further include an indicator, which graphically illustrates the minimum desired speed (in feet per minute). The “wire feed speed” chart 910 may also include an indicator, which graphically illustrates the minimum speed of concern (in feet per minute) below which is an indication of improper or inefficient welding. The “machine average wire feed speed” data or information may illustrate the average wire feed speed (in feet per minute) per welding machine. The “machine average wire feed speed” data or information may be calculated on a per shift basis, or on a per period basis. In an embodiment, one period may be three hours long, and there may be four periods in a shift.

Following completion of the welding project 105, or during various stages of the welding project, the representative diagram of a seventh sheet of FIG. 11, entitled “customer production summary,” may be provided to a customer in order to inform them of the progress of the welding project 105 (step 485 of FIG. 4). In an embodiment, the seventh sheet of FIG. 11 may include various base data, performance data, and optimization data, in order to provide a convenient and succinct summary of the progress of the welding project 105 to a customer. The base data may include, for example as in area 1100, a project number; an overlay start date; a number of shifts scheduled; a shift start date; and a projected end date. The performance data may include, for example as in area 1105, the numerical area (in square feet) of the boiler tubes and membranes having been overlaid to date. The optimization data may include, for example as in area 1110, the numerical total area (in square feet) of the boiler tubes and membranes having been overlaid to date. The optimization data may further include, for example as in area 1115, the “project progress against schedule” graph. The “project progress against schedule” graph displayed in area 1115 may illustrate comparative graphical line-charts representing the percent of the project completed over time against the percent of the project as scheduled to be completed over time. The optimization data may further include, for example as in area 1120, the “productivity by weld zone” graph. The “productivity by weld zone” graph displayed in area 1120 may illustrate bar graphs showing the average area (in square feet) welded per hour, by weld zone.

Following completion of the welding project 105, the representative diagram of a eighth sheet of FIG. 11, entitled “project summary,” may be completed (step 490 of FIG. 4). In an embodiment, the “project summary” may be used to formulate base data (step 410 of FIG. 4) or anticipate the needs as required by the base data of future welding projects (step 495 of FIG. 4). For example, the anticipated needs may include: the total pounds of alloy likely to be used during a project; the optimal number of welding apparatuses necessary to safely, efficiently, and timely complete the welding project; and the optimal number of operators necessary to safely, efficiently, and timely complete the welding project. In an embodiment, the seventh sheet of FIG. 12 may include various base data and optimization data. The base data may include, for example as in area 1200: a project number; a project customer; a project manager; a lead superintendent; a planned project state date; a size of the area (in square feet) overlaid; an alloy type; and a projected end date. The optimization data may include, for example as in area 1205: the total man-hours to complete the project; the average area (in square feet) overlaid per hour; the average area (in square feet) overlaid per welding apparatus; the average wire feed speed (in square feet per hour); the total amount of wire used (in pounds); and the average amount of wire used (in pounds per square feet).

While certain embodiments of the present diagnostic tool and methods of use have been described in connection with various preferred illustrative embodiments shown herein, it will be understood that it is not intended to limit the diagnostic tool or methods of use to those embodiments. On the contrary, it is intended to cover all alternatives, modifications, and equivalents, as may be included within the spirit and scope of the diagnostic tool and methods of use as defined by the appended claims. Further, it should be understood that the use of an English unit is also a disclosure of alternative English units as well as Scientific units. As a non-limiting example, where the disclosure suggests a measurement in pounds, it should also be understood that equivalent measurements may be taken in ounces, grams, kilograms, and the like.

I claim:

1) A computer readable medium for use in connection with a welding project, the welding project having a plurality of weld zones, each weld zone having a plurality of welding apparatuses, each welding apparatus working a plurality of daily apparatus shifts, the computer readable medium comprising:
means for receiving base data relating to each of the plurality of weld zones;
means for receiving performance data relating to each welding apparatus;
means for transforming the base data and the performance data into optimization data; and
means for displaying the optimization data.

2) The computer readable medium of claim 1, wherein each weld zone further includes a plurality of operators, each operator working a plurality of daily operator shifts, the computer readable medium further comprising means for receiving performance data relating to each operator.

3) The computer readable medium of claim 2, wherein the base data includes at least one planned element selected from the group consisting of: a project identifier, an overlay start date, a number of total shifts, a shift-start date, a customer name, a project manager name, a lead superintendent name, an alloy type, a project duration, a project start date, a number of weld zones, a number of welding apparatuses per each weld zone, a total area of overlay, a number of spools, and an amount of wire per spool.

4) The computer readable medium of claim 3, wherein the performance data includes at least one progress element selected from the group consisting of: number of targets overlaid per welding apparatus, number of targets overlaid per operator, size of targets overlaid per welding apparatus, size of targets overlaid per operator, wire feed speed per welding apparatus, wire feed speed per operator, wire used per welding apparatus, wire used per operator, area overlaid per welding apparatus, and area overlaid per operator.

5) The computer readable medium of claim 4, wherein the optimization data includes at least one generated element selected from the group consisting of: productivity per shift, productivity per welding apparatus, productivity per operator, progress per project, progress per weld zone, progress per operator, progress per welding apparatus, wire gage consumed per weld zone, wire gage remaining per weld zone.

6) A method of using a computer program for adjusting a wire feed speed of a welding apparatus, the computer program embodied on a computer readable medium having computer-executable instructions, the method comprising:
identifying at least one welding project having a plurality of weld zones, each weld zone having a plurality of welding apparatuses, each welding apparatus working a plurality of daily apparatus shifts;
inputting base data of the welding project into a computer readable database;
obtaining performance data of the welding project at least one time per daily apparatus shift;
inputting the performance data of the welding project into a second computer readable database;
obtaining wire-feed data of the welding project at least two times per daily apparatus shift;
inputting the wire-feed data into a third computer readable database;
using the computer program to transform the base data, performance data, and wire-feed data into optimization data, the optimization data including at least one generated element selected from the group consisting of: productivity per welding apparatus and progress per welding apparatus;
displaying the optimization data on a screen;
visually inspecting the displayed optimization data;
identifying a welding apparatus having departing optimization data; and
adjusting the wire feed speed of the welding apparatus having departing optimization data.

7) A method of using a computer program for adjusting a welding project, the welding project, the welding project having a plurality of weld zones, each weld zone having a plurality of welding apparatuses, each welding apparatus operated by an operator, each welding apparatus working a plurality of daily apparatus shifts, each operator working a plurality of daily operator shifts, the computer program embodied on a computer readable medium having computer-executable instructions, the method comprising:
identifying at least one welding project having a plurality of weld zones, each weld zone having a plurality of welding apparatuses, each welding apparatus operated by an operator, each welding apparatus working a plurality of daily apparatus shifts, and each operator working a plurality of daily operator shifts;
inputting base data of the welding project into a computer readable database;
obtaining performance data of the welding project at least one time per daily apparatus shift;
inputting the performance data of the welding project into a second computer readable database;
obtaining wire-feed-speed data of the welding project at least two times per daily apparatus shift;
inputting the wire-feed-speed data into a third computer readable database;
using the computer program to transform the base data, performance data, and wire-feed-speed data into optimization data, the optimization data including at least one generated element selected from the group consisting of: productivity per welding apparatus and progress per welding apparatus;
displaying the optimization data on a screen;
inspecting the displayed optimization data;
identifying a welding apparatus, or operator, having departing optimization data; and
adjusting the welding apparatus, or operator, having departing optimization data.

8) A diagnostic tool for use for adjusting a welding project, the welding project having a plurality of weld zones, each weld zone having a plurality of welding apparatuses, each welding apparatus operated by an operator, each welding apparatus working a plurality of daily apparatus shifts, each operator working a plurality of daily operator shifts, the diagnostic tool comprising:
an input device adapted to transfer base data relating to each of the plurality of weld zones into a first computer readable database, the input device further adapted to transfer performance data relating to each welding apparatus into a second computer readable database;
a computer program adapted to transform the base data and the performance data into optimization data; and
an output device adapted to display the optimization data.
